(19) United States
(12) Patent Application Publication
(10) Pub. No.: US 2009/0041504 A1
(43) Pub. Date: Feb. 12, 2009

(54) Light Exposure Head and Image Formation Apparatus Using the Same

(75) Inventors: Kenji YAMAGUCHI, Matsumoto-shi (JP); Nozomu INOUE, Matsumoto-shi (JP); Yujiro NOMURA, Shiojiri-shi (JP)

Correspondence Address: HOGAN & HARTSON L.L.P., 1999 AVENUE OF THE STARS, SUITE 1400, LOS ANGELES, CA, 90067, US

(73) Assignee: Seiko Epson Corporation, Tokyo (JP)

(21) Appl. No.: 12/188,045

(22) Filed: Aug. 7, 2008

(30) Foreign Application Priority Data
Aug. 7, 2007 (JP) 2007-204900
Jul. 4, 2008 (JP) 2008-175398

(51) Int. Cl. G03G 15/04

(52) U.S. Cl. 399/220

(57) ABSTRACT

A light exposure head includes a base; a substrate disposed on the base, the substrate having a plurality of light emitting elements disposed thereon; and n (n is an integer greater than or equal to one) imaging optical systems, each of which having a negative optical magnification, the imaging optical systems focusing light beams emitted from the plurality of light emitting elements disposed on the substrate.

### CROSS REFERENCE TO RELATED ART

The disclosure of Japanese Patent Applications No. 2007-204900 filed on Aug. 7, 2007 and No. 2008-175398 filed on Jul. 4, 2008 including specification, drawings and claims is incorporated herein by reference in its entirety.

### BACKGROUND

1. Technical Field

The present invention relates to a light exposure head that allows reduction in image quality degradation and an image formation apparatus using the same.

2. Related Art

An LED-based line head has been known as a light exposure source in an image formation apparatus. Japanese Patent No. 2868175 proposes a technology for improving resolution without reducing the intervals at which light emitters are arranged in a light emitter array. FIGS. 17A and 17B are descriptive diagrams showing a schematic configuration of an image formation apparatus using the line head disclosed in Japanese Patent No. 2868175. FIG. 17A is a view of the image formation apparatus in the axial direction of a photoconductor 11, and FIG. 17B is a perspective view of the image formation apparatus viewed from obliquely above the photoconductor 11.

Light emitter arrays 31 and 32 are arranged in n rows (n=2 in this example) on a substrate 1, and monocular lenses 33 and 34 are provided in such a way that the monocular lenses are in one-to-one correspondence with the light emitting arrays. The monocular lenses 33 and 34 are arranged in such a way that the optical axes thereof are shifted from the center lines of the light beams from the light emitter arrays 31 and 32. In such a configuration, the light beams from the n rows of light emitter arrays are focused on the same line 35 on the photoconductor 11.

Japanese Patent No. 3388193 describes a method for compensating image quality degradation resulting from curvature and obliquity of a line head. According to Japanese Patent No. 3388193, an optical sensor or any other similar device is first used to measure the curvature and obliquity of the line head, and the measured curvature information and obliquity information are added to calculate precision information, which is then stored in a precision information storage device, such as an EEPROM (non-volatile memory). When a printer is turned on, the precision information is read from the precision information storage device and allocated in a RAM or any other similar device that is accessible at high speed. When a printing operation starts, image data is written on an image memory, such as an SRAM. Image information on each pixel is read from the image memory in accordance with an offset value determined from the precision information that corresponds to a dot number i, and the readout is transferred to a line buffer. When image information that correspond to one line is accumulated, the accumulated image information is transferred to the line head, and the line head emits light to form an image to be printed on a sheet of paper. Such processes to compensate image quality degradation resulting from the curvature and obliquity of the line head are repeated until the entire page is filled.

When a line head on which light emitting elements are mounted is attached to a body, the line head may be fixed at a position deviated from a reference attachment position in some cases. This deviation is called skew registration deviation (obliquity) and causes image quality degradation. FIG. 19A is a descriptive diagram showing such skew registration deviation. LED chips 35 on each of which a plurality of LED elements 36 are mounted are linearly arranged in the axial direction (primary scan direction) of a photoconductor to form a line head. In FIG. 19A, the line head is fixed on the body and inclined to the reference line. C.L stands for the center line of a substrate. Skew registration deviation may also occur when an organic EL element is used as the light emitting element.

Further, when LEDs are used as the light emitting elements mounted on a line head, the LED chips attached on the substrate may form a curved line, resulting in curvature registration deviation. FIG. 19B is a descriptive diagram showing such curvature registration deviation. The LED chips 35a to 35g except the LED chip 35b are mounted along a curved line deviated from the center line C.L of the substrate.

When LED chips are mounted on a line head, the skew registration deviation and the curvature registration deviation described above may be produced and combined. FIG. 19C is a descriptive diagram showing a case where such skew registration deviation and curvature registration deviation are produced and combined.

To address the above problems, the applicant has proposed in Japanese Patent Application Nos. 2006-234197 and 2007-96932 solutions that reduce image quality degradation resulting from such positional deviation of a line head. Japanese Patent Application Nos. 2006-234197 and 2007-96932 propose methods for correcting the deviation in the axial direction of the photoconductor (primary scan direction) on an LED chip basis (an LED chip is formed of a predetermined number of light exposure elements controllable by a single drive circuit) and correcting the deviation in the direction in which the photoconductor moves (secondary scan direction) on a line basis (on a dot basis).

FIG. 20 is a flowchart of an exemplary method for acquiring positional deviation data for the line head described in the examples shown in FIGS. 19A to 19C, and FIGS. 21A to 21D are descriptive diagrams of the flow. In FIG. 20, the amount of curvature deviation of each LED chip is measured when the line head is manufactured (S20). In FIG. 21A, the amount of curvature deviation B of each of the LED chips 35a to 35g from the center line C.L of the substrate is measured.

In FIG. 20, the line head is then attached to an image formation apparatus, and the amount of curvature deviation of each of the LED chips is stored in a memory in advance before the image formation apparatus is shipped (S21). The process corresponds to storing the amount of curvature deviation E of each of the LED chips in a memory 37 in advance in FIG. 21B. The memory 37 can be an EEPROM, as will be described later. Subsequently, in FIG. 20, the amount of deviation of each of the LED chips is read during printing. The amount of deviation is obtained by adding the amount of skew deviation to the amount of curvature deviation (S23). The process corresponds to the process in FIG. 21C. In the example shown in FIGS. 20 and 21A to 21D, although a case where an LED is used as the light emitting element is described, similar processes are carried out when an organic EL element is used as the light emitting element.

FIG. 21D is a descriptive diagram of a case where print start timing for each of the LED chips is adjusted in accordance with the amount of deviation F of the LED chip. The adjustment of the print start timing for light emitting elements will be described with reference to descriptive diagram of FIGS. 22A to 22D. FIG. 22A shows original image data, that is, printable image data Pa created by an external controller or any other similar apparatus. The LED chips 35a to 35g are arranged in the line head in positions deviated from the LED chip 35c located at a reference position, as shown in FIG. 22C.

FIG. 22B diagrammatically shows memories that are used to drive the LED chips. For example, the LED chip 35a is disposed in a position deviated from the LED chip 35c at the reference position by two lines in the Y direction in which the photoconductor rotates. The two-tier memory 37a therefore delays the drive timing of the LED chip 35a by two lines relative to the LED chip 35c at the reference position.

Since the print start timing that corresponds to the amount of deviation of each of the LED chips from the reference position in the secondary scan direction is adjusted by using memories 37, it is possible to reduce image quality degradation resulting from positional deviation of the LED chip. FIG. 22D shows latent images Pb formed on the photoconductor. As shown in FIG. 22D, the image data Pb identical to the original image data Pa are formed on the photoconductor.

In the example described in Japanese Patent No. 2868175, when a drive system set to operate at a certain printing speed or period fluctuates (vibrates) between values around the thus set speed or period, banding occurs. For example, when a gear is used in the drive system, the speed fluctuates in accordance with the pitch of the gear, and the change in the speed causes banding on an image, resulting in a striped image. The image quality is therefore disadvantageously degraded. FIG. 18A shows an original image, and FIG. 18B shows an image formed in the imaging plane when banding occurs.

Since the line head shows combined skew registration deviation and curvature registration deviation, positions of latent images on the photoconductor are deviated (deviation in light exposure position), disadvantageously resulting in image quality degradation. In the methods for addressing the problem described in Japanese Patent No. 3388193, and Japanese Patent Application Nos. 2006-234197, and 2007-96932, a large amount of memory capacity is disadvantageously required to hold deviation data for each dot in the secondary scan direction as shown in FIG. 22.

### SUMMARY

An advantage of some aspects of the invention is to provide a line head that alleviates the disadvantageous effect of banding and corrects latent image position deviation to improve image quality at low cost, an image formation apparatus using the same, and an image formation method.

A light exposure head according to a first aspect of the invention includes a base; a substrate disposed on the base, the substrate having a plurality of light emitting elements disposed thereon; and n (n is an integer greater than or equal to one) imaging optical systems, each of which having a negative optical magnification, the imaging optical systems focusing light beams emitted from the plurality of light emitting elements disposed on the substrate.

It is preferable in the light exposure head according to the first aspect of the invention that a plurality of the substrates are disposed on the base in a first direction, and light beams emitted from the light emitting elements disposed on an adjacent substrate in the first direction are focused by a different imaging optical system.

It is preferable in the light exposure head according to the first aspect of the invention that a plurality of the substrates are disposed in a second direction perpendicular to the first direction.

It is preferable in the light exposure head according to the first aspect of the invention that one of the imaging optical systems focuses light beams emitted from the light emitting elements disposed on any of the plurality of the substrates disposed in the second direction.

It is preferable in the light exposure head according to the first aspect of the invention that a plurality of the imaging optical systems are disposed in the first direction to form a row of imaging optical systems, and a plurality of the rows of imaging optical systems are disposed in the second direction.

A light exposure head according to a second aspect of the invention includes a base; a first substrate disposed on the base, the first substrate having a plurality of light emitting elements thereon; a second substrate disposed on the base and adjacent to the first substrate in a first direction, the second substrate having a plurality of light emitting elements thereon; a first imaging optical system having a negative optical magnification, the first imaging optical system focusing light beams emitted from the plurality of light emitting elements disposed on the first substrate; and a second imaging optical systems having a negative optical magnification, the second imaging optical system focusing light beams emitted from the plurality of light emitting elements disposed on the second substrate.

It is preferable in the light exposure head according to the second aspect of the invention that the imaging optical system is formed of two or more lenses.

It is preferable in the light exposure head according to the second aspect of the invention that the light emitting element is an LED.

It is preferable in the light exposure head according to the second aspect of the invention that the light emitting elements are segmented into groups of light emitting elements, and light beams emitted from one of the groups of light emitting elements are focused by one of the imaging optical systems.

An image formation apparatus according to a third aspect of the invention includes a light exposure head including a base, a plurality of substrates disposed on the base in a first direction, a plurality of light emitting elements disposed on each of the substrate, and n (n is an integer greater than or equal to one) imaging optical systems, each of which having a negative optical magnification, the imaging optical systems focusing light beams emitted from the plurality of light emitting elements; a photoconductor on which the light exposure head forms latent images, the photoconductor moving in a second direction perpendicular or substantially perpendicular to the first direction; and a developing device that develops the latent images.

It is preferable in the image formation apparatus according to the third aspect of the invention that light beams emitted from the plurality of light emitting elements disposed on the plurality of substrates are focused on the photoconductor by different imaging optical systems.

It is preferable in the image formation apparatus according to the third aspect of the invention that the imaging optical systems are disposed in the second direction, and the imaging optical systems disposed in different positions in the second direction form images on the photoconductor in different positions in the second direction.

According to any of the above embodiments, light emission control of the light exposure head allows correction including positional errors of the imaging optical system and mounting errors of the substrates.

With the light exposure head and the image formation apparatus according to any of the above embodiments, perceptible, periodic grayscales resulting from, for example, skew registration deviation and curvature registration deviation produced by attaching the substrates to the base are dispersed in all directions in an image to be formed, whereby image quality degradation due to the above effects can be reduced.

With the light exposure head and the image formation apparatus according to any of the above embodiments, since the locations where grayscales resulting from banding are produced are dispersed in all directions in an image to be formed, image quality degradation due to banding becomes less noticeable.

It is confirmed that the following reference embodiments associated with the invention are effective configurations. That is, a line head according to a reference embodiment of the invention includes a lens array having a plurality of lenses arranged therein in the axial direction of a photoconductor (primary scan direction), each of the lenses having a negative optical magnification, and a chip having light emitting elements mounted thereon and disposed to face the lens array. The chip has groups of light emitting elements formed thereon in correspondence with the individual lenses, and light emission timings of the groups of light emitting elements are controlled in correspondence with the individual lenses.

In a line head according to a reference embodiment of the invention, a plurality of the chips and the lens arrays are disposed in the axial direction of the photoconductor.

In a line head according to a reference embodiment of the invention, a plurality of the chips and the lens arrays are disposed in the direction in which the photoconductor moves (secondary scan direction).

In a line head according to a reference embodiment of the invention, the chips are inclined to the direction in which the photoconductor moves, and the groups of light emitting elements formed on each of the chips are disposed in positions facing the lenses in each of the lens arrays disposed in the plurality of rows in the direction in which the photoconductor moves.

In a line head according to a reference embodiment of the invention, latent images are formed in different positions for each row in the direction in which the photoconductor moves.

In a line head according to a reference embodiment of the invention, the groups of light emitting elements and lens arrays are disposed in a staggered manner.

In a line head according to a reference embodiment of the invention, the number of dots in the group of light emitting elements is a positive divisor of the number of dots in the chip.

In a line head according to a reference embodiment of the invention, the light emitting element is an LED, and the chip is an LED chip.

An image formation apparatus according to a reference embodiment of the invention includes at least two image formation stations including the following image formation units: a charging unit disposed around an image carrier, the line head according to any of the above embodiments, a developing unit, and a transferring unit. When a transfer medium passes through the image formation stations, an image is formed in a tandem manner.

### BRIEF DESCRIPTION OF THE DRAWINGS

The invention will now be described with reference to the accompanying drawings, wherein like numbers reference like elements.

FIG. 1 is a descriptive diagram showing an embodiment of the invention.

FIG. 2 is a descriptive diagram showing an embodiment of the invention.

FIG. 3 is a descriptive diagram showing an embodiment of the invention.

FIG. 4 is a descriptive diagram showing an embodiment of the invention.

FIG. 5 is a descriptive diagram showing an example in which light exposure position deviation is not corrected.

FIG. 6 is a descriptive diagram showing an embodiment of the invention.

FIG. 7 is a descriptive diagram showing an embodiment of the invention.

FIG. 8 is a descriptive diagram showing an embodiment of the invention,

FIGS. 9A and 9B are descriptive diagrams showing an embodiment of the invention.

FIG. 10 is a descriptive diagram showing an embodiment of the invention.

FIGS. 11A to 11E are descriptive diagrams showing an embodiment of the invention.

FIG. 12 is a block diagram of showing an embodiment of the invention.

FIG. 13 is a flowchart showing a process procedure of the invention.

FIG. 14 is a block diagram of showing an embodiment of the invention.

FIG. 15 is a flowchart showing a process procedure of the invention.

FIG. 16 is a descriptive diagram showing an embodiment of the invention.

FIGS. 17A and 17B are descriptive diagrams showing an embodiment of the invention.

FIGS. 18A to 18B are descriptive diagrams showing an embodiment of the invention.

FIGS. 19A to 19C are longitudinal side cross-sectional views of an image formation apparatus according to an embodiment of the invention.

FIG. 20 is a descriptive diagram showing an example of related art.

FIGS. 21A to 21D are descriptive diagrams showing an example of related art.

FIGS. 22A to 22D are descriptive diagrams showing an example of related art.

FIG. 23 is a descriptive diagram showing an example of related art.

FIG. 24 is a descriptive diagram showing another embodiment of the invention.

FIG. 25 is a descriptive diagram showing another embodiment of the invention.

FIG. 26 is a descriptive diagram showing another embodiment of the invention.

### DESCRIPTION OF EXEMPLARY EMBODIMENTS

The invention will be described below with reference to the drawings. FIGS. 9A and 9B are descriptive diagrams showing an embodiment of the invention. FIG. 9A is a cross-sectional view of a photoconductor 11 viewed in the axial direction. FIG. 9B is a perspective view of the photoconductor 11 and a line head 10 viewed from obliquely above. The line head 10 has two rows of light emitter arrays 38 and 39 on a substrate 1 arranged in the direction in which the photoconductor 11 moves (Y direction). Each of the light emitter arrays 38 and 39 has a plurality of light emitting elements disposed along the axial direction (primary scan direction) of the photoconductor 11. Reference numerals 4 and 5 denote imaging lens arrays formed of micro-lens arrays (MLAs) using micro-lenses having a negative optical magnification. The light beams outputted from the light emitting elements pass through the imaging lens arrays 4 and 5 and form latent images in difference positions 12 and 13 on the photoconductor 11.

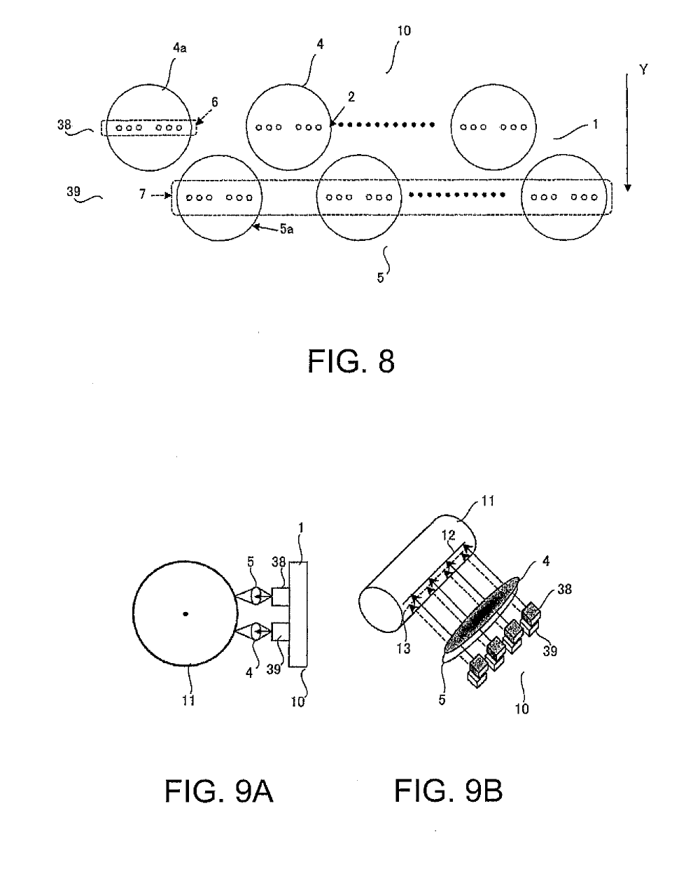

FIG. 8 is a descriptive diagram showing the positional relationship between the light emitter arrays 38, 39 and the imaging lens arrays 4, 5 shown in FIGS. 9A and 9B. In FIG. 8, a plurality of light emitting elements 2 are arranged on the substrate 1 along the axial direction of the photoconductor (latent image carrier) 11 to form rows of light emitting element groups 7. The rows of light emitting element groups 7 correspond to the light emitter arrays 38 and 39. In the example shown in FIG. 8, the two light emitter arrays 38 and 39 are arranged in the direction in which the photoconductor moves (Y direction). The imaging lens arrays 4 and 5 are arranged in correspondence with the light emitter arrays 38 and 39, respectively. Reference character Y denotes the direction in which the photoconductor moves (the direction perpendicular to the axial direction, secondary scan direction). That is, the plurality of imaging lens arrays 4 and 5 are arranged in the direction in which the photoconductor moves.

Individual imaging lenses 4a and 5a in the imaging lens arrays 4 and 5 are related to light emitting element groups 6 obtained by segmenting the light emitting elements 2 into a plurality of groups. For example, the light emitter array 39 is, as a row of light emitter groups 7, related to the imaging lens array 5. That is, in the embodiment of the invention, a plurality of imaging lens array rows are arranged in the direction in which the photoconductor moves, and individual imaging lenses are related to light emitting element groups. Further, a single imaging lens array row disposed in the axial direction of the photoconductor is related to a single row of light emitter groups. While in the example shown in FIG. 8 and FIGS. 9A and 9B, an LED is used as the light emitting element 2, an organic EL element can also be used.

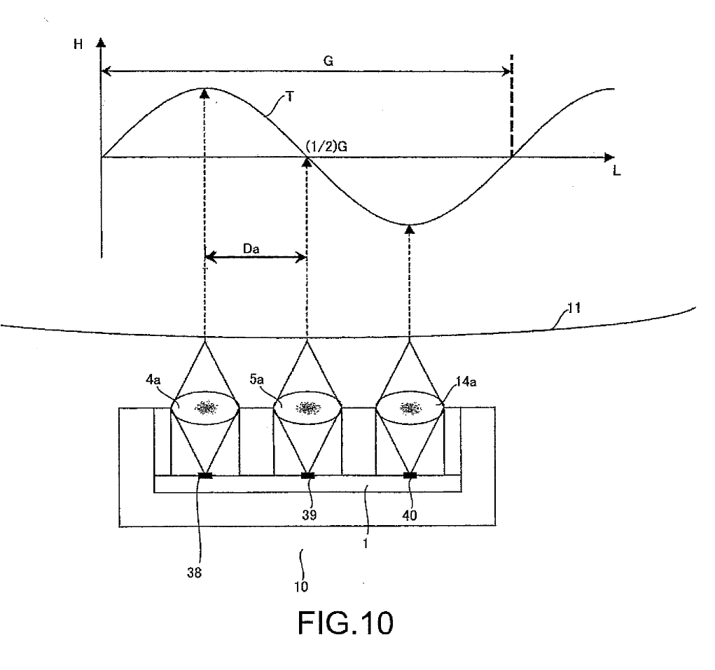

FIG. 10 is a descriptive diagram showing an embodiment of the invention. In FIG. 10, the line head 10 has light emitter arrays 38 to 40 arranged on the substrate 1, each of the light emitter arrays 38 to 40 linearly arranged in the axial direction of the photoconductor 11. Reference numerals 4a, 5a, and 14a denote imaging lenses. The vertical axis H of the characteristic diagram represents variation in speed resulting from banding generated in a driver that drives the photoconductor 11, and the horizontal axis L represents the distance in the direction perpendicular to the axial direction of the photoconductor 11. The speed variation characteristic T in the diagram periodically varies in a cycle of a gear pitch G of the driver that drives the photoconductor 11.

In the embodiment of the invention, as described with reference to FIGS. 9A and 9B, the image formation position for one of the lens array rows differs from the image formation position for the other lens array row in the direction in which the photoconductor rotates. Therefore, a row of latent images formed on the photoconductor 11 in the axial direction (primary scan direction) serpentines. The interval Da between the imaging lenses 4a and 5a (interval in the secondary scan direction) corresponds to the interval between rows of latent images formed on the photoconductor. Setting the interval Da to a value longer than one-half the gear pitch G of the driver causes peaks and valleys of the speed variation characteristic T to cancel each other, whereby the disadvantageous effect of banding can be less noticeable.

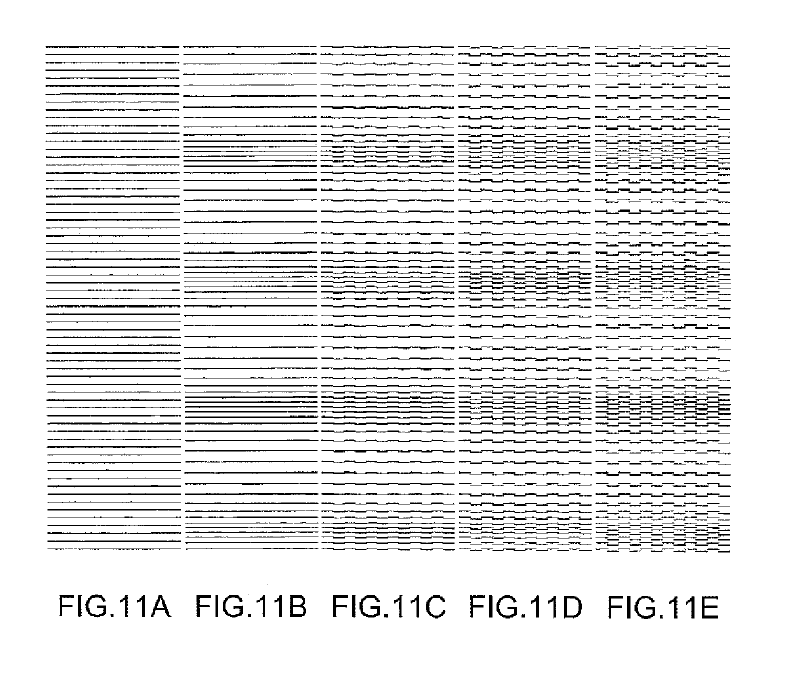

FIGS. 11A to 11E are descriptive diagrams showing examples of rows of latent images formed on the photoconductor. FIG. 11A shows an original image. FIG. 11B is an example of rows of latent images according to related art. FIGS. 11C to 11E show examples of rows of latent images according to the embodiment of the invention obtained by changing the interval Da between imaging lenses in the secondary scan direction. As described above, since rows of latent images in the primary scan direction serpentine in the embodiment of the invention, degradation in image quality due to the banding can be smaller than the degradation seen in rows of latent images according to related art. It is noted that the intervals between imaging lenses in the secondary scan direction (intervals between rows of latent images) are set to satisfy (c)<(d)<(e).

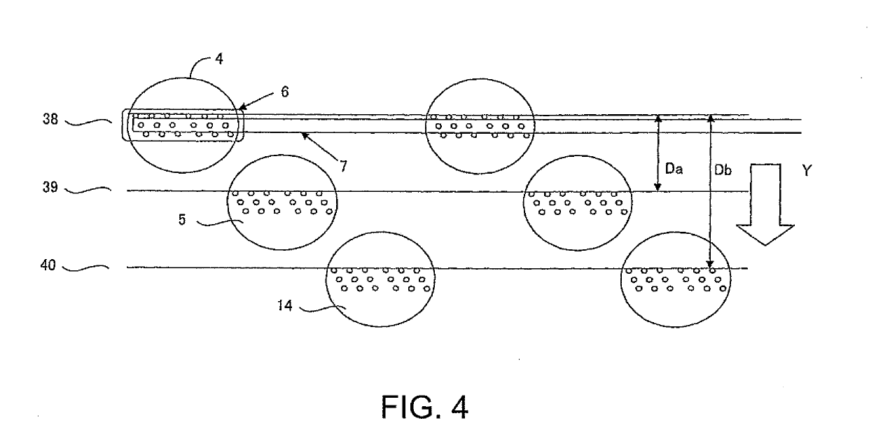

FIG. 4 is a descriptive diagram of an example of how to calculate the number of MLA correction lines in the secondary scan direction. Discrete imaging lenses 4, 5, 14 are disposed in imaging lens arrays 38 to 40, respectively. A row of light emitting element groups 7 is disposed in correspondence with the imaging lens array 38. Reference numeral 6 denotes a group of light emitting elements. Similarly, rows of light emitting element groups are disposed in correspondence with the other imaging lens array 39 and 40. To correct MLA light exposure position deviation for each row of the light emitting elements on a line basis (resolution in the secondary scan direction), the number of correction lines Nhn can be determined by using the intervals Da and Db between rows of imaging lenses and the photoconductor surface speed Vopc in the following equation (1) and (2).

For the lens-to-lens interval Da, light exposure delay time Tdly for a row of light emitting elements is given by the following equation:

Tdly=Da/Vopc (1)

The number of MLA correction lines Nhn is given by the following equation:

Nhn=Tdly/Thr (2)

where Thr represents the period required to transfer one line data. In practice, the number of lines Nhn is determined by rounding off the result of the division to the nearest integer.

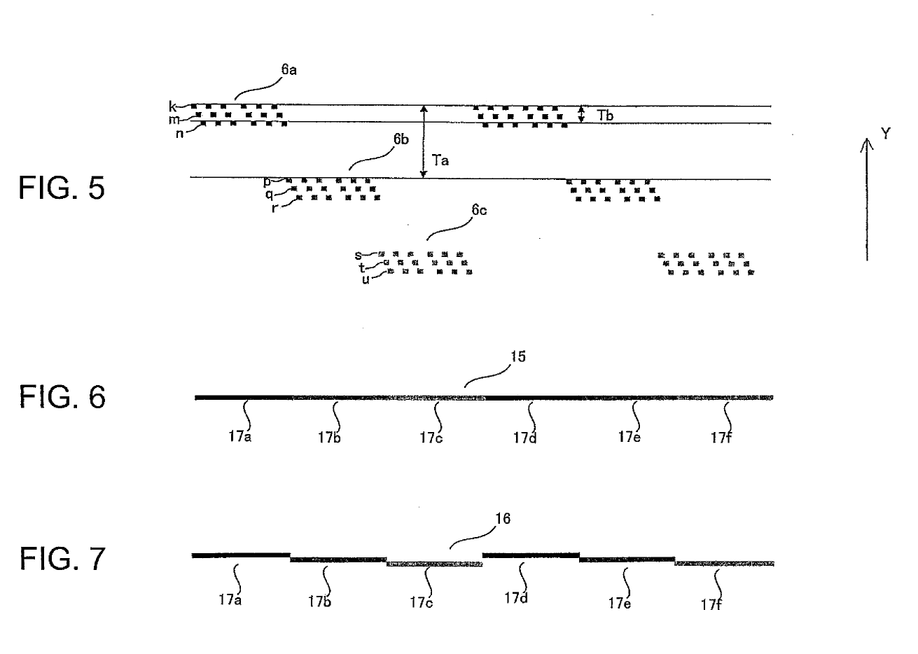

FIG. 5 is a descriptive diagram showing latent images when the MLA light exposure position deviation is not corrected. In FIG. 5, Ta represents MLA light exposure position deviation between lens rows, and Tb represents MLA light exposure position deviation in a single lens. Reference numerals 6a, 6b, and 6c denote latent image patterns formed on the photoconductor by the output light beams that have passed through the imaging lens arrays 38, 39, and 40 described in FIG. 10.

FIG. 6 is a descriptive diagram showing latent images when the MLA light exposure position deviation is corrected. In this case, latent images 15 are formed on the photoconductor by the output light beams that have passed through the MLs, as indicated by reference characters 17a to 17f. That is, the latent images are formed linearly in the axial direction (primary scan direction) of the photoconductor. Degradation in image quality can thus be reduced. Assuming the photoconductor moves in the Y direction, the correction is made in the following manner. For the latent image pattern 6a shown in FIG. 5, the light exposure position deviation in a single lens is corrected with reference to the latent image row k. That is, the formation of the latent image row m is delayed by one row relative to the latent image row k. The formation of the latent image row n is delayed by two rows relative to the latent image row k.

Similarly, for the latent image patterns 6b and 6c, the light exposure position deviation is corrected by delaying the formation of the latent image row of interest by one row relative to the previous latent image row. To correct the light exposure position deviation between lens rows, the formation of the latent image pattern 6b is delayed by one timing period in the Y direction with reference to the latent image pattern 6a, and the formation of the latent image pattern 6c is delayed by two timing periods in the Y direction. Therefore, in practice, to correct the light exposure position deviation, the latent image row k in the latent image pattern 6a is used as a reference and the formation of each of latent image rows m to u is delayed by one row relative to the previous latent image row in the Y direction.

FIG. 7 is a descriptive diagram showing another example of latent image formation. Since the intervals between MLA lens rows and the diameter of the photoconductor vary from component to component, the interval Da between lens rows and the photoconductor surface speed Vopc contain errors. That is, differences in individual MLAs and photoconductors result in different numbers of MLA correction lines Nhn. Therefore, since the actual number of MLA correction lines may differ from that determined from an ideal lens-to-lens interval and an ideal photoconductor surface speed, differences in individual MLAs and photoconductors produce a slight step (light exposure timing deviation between lenses) at the boundary between lenses when an actual image formation apparatus is used to draw linear latent images in the primary scan direction. FIG. 7 shows latent images with slight steps produced at lens boundaries due to differences in individual MLAs and photoconductors when MLA light exposure position deviation is corrected.

In the line head with MLAs, when the obliquity and curvature deviation is corrected on a chip basis (resolution in the primary scan direction), and the number of dots per chip (the number of dots per LED chip) differs from the number of dots per lens (the number of dots per light emitting element group), light exposure timing deviation between lenses resulting from an error in the diameter of the photoconductor and an error in the lens interval cannot be corrected, resulting in vertical stripes associated with the lens interval in a printed image. Conversely, when the obliquity and curvature deviation is corrected on a light emitting element group basis (resolution in the primary scan direction), and the number of dots per LED chip differs from the number of dots per light emitting element group, deviation between LED chips cannot be corrected, resulting in vertical stripes associated with the LED chip interval in a printed image.

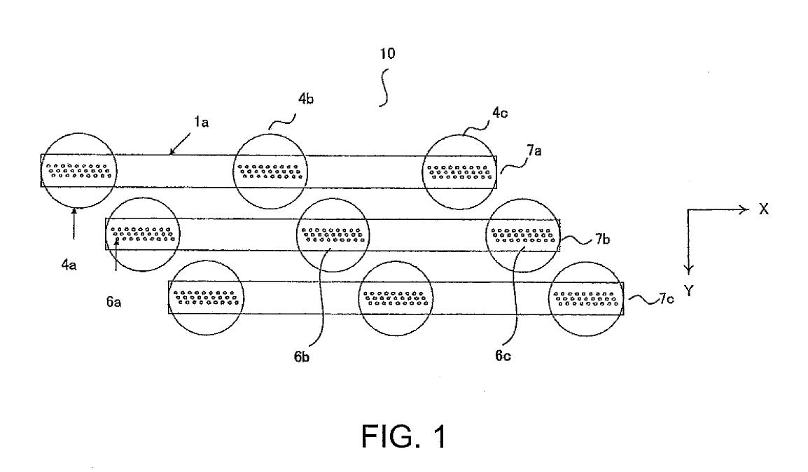

An embodiment of the invention seeks to solve the above problems. FIG. 1 is a descriptive diagram showing an embodiment of the invention. In the line head 10 shown in FIG. 1, reference character la denotes a light emitter array chip on which light emitting element groups 6a, 6b, and 6c are mounted on a single chip substrate. Imaging lenses 4a, 4b, and 4c are arranged in correspondence with the light emitting element groups. The plurality of imaging lenses 4a, 4b, and 4c arranged in the primary scan direction form an imaging lens array 7a. Reference character x denotes the axial direction of the photoconductor (primary scan direction), and reference character Y denotes the direction in which the photoconductor moves (secondary scan direction).

In the example of the line head 10 shown in FIG. 1, nine imaging lenses, therefore, nine sets of light emitting element groups are arranged on three light emitter array chips. Now, for the single light emitter array chip 1a, the number of dots per light emitting element group for a single imaging lens (A) is compared with the number of dots per light emitter array chip (B). The number of dots per light emitting element group (A) is 27, and the number of dots per light emitter array chip (B) is 27×3=81. That is, A is set to be a positive divisor of B (the greatest common divisor is 27 in this case).

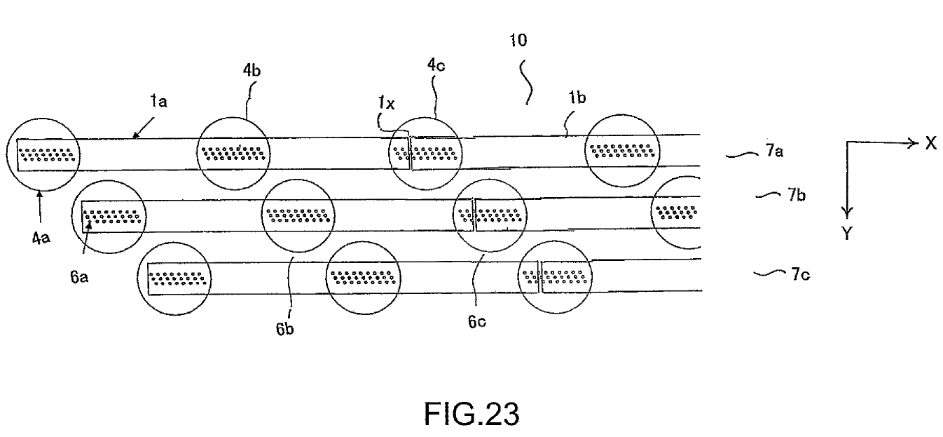

In this way, the number of dots per light emitting element group (A) is selected to be a divisor of the number of dots per light emitter array chip (B), and the operation timings of the light emitting element groups are controlled in correspondence with respective individual imaging lenses. The light exposure timing deviation between lenses resulting from an error in the diameter of the photoconductor and an error in the imaging lens interval can thus be corrected, resulting in no vertical stripes associated with the lens interval in a printed image unlike the situation described with reference to FIG. 7. The reason of this will be described later with reference to FIG. 23.

When the obliquity and curvature deviation of the line head is corrected on a light emitting element group basis (resolution in the primary scan direction), deviation between light emitter array chips can be corrected because the number of dots per light emitting element group (A) is selected to be a positive divisor of the number of dots per light emitter array chip (B), resulting in no vertical stripes associated with the light emitter array chip interval in a printed image.

In the configuration shown in FIG. 1, the light emitter array chip can be formed of LED chips; the imaging lens can be formed of a micro-lens (ML) having a negative optical magnification; and the imaging lens array can be formed of a micro-lens array (MLA). The thus configured embodiment of the invention is configured in such a way that a light emitting element group formed on a single light emitter array chip corresponds to a single imaging lens having a negative optical magnification, and applied to a line head in which light emission timings of light emitting element groups are controlled in correspondence with respective imaging lenses to correct obliquity and curvature deviation.

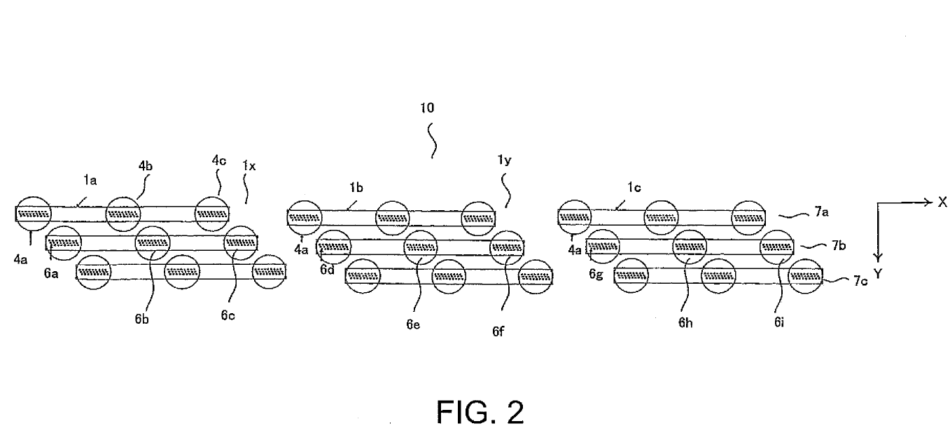

FIG. 2 is a descriptive diagram showing a detailed configuration of the line head shown in FIG. 1. In this example, light emitter array chips 1a to 1c are arranged in the primary scan direction (X direction) in correspondence with imaging lens arrays 7a to 7c. The array chips are arranged with a gap 1x or 1y therebetween. The first light emitting element group 6a in the secondary scan direction of each of the light emitter array chips that correspond to the imaging lens arrays 7a to 7c is disposed in such a way that the position of the first light emitting element group is slightly shifted in the primary scan direction relative to the previous first light emitting element group.

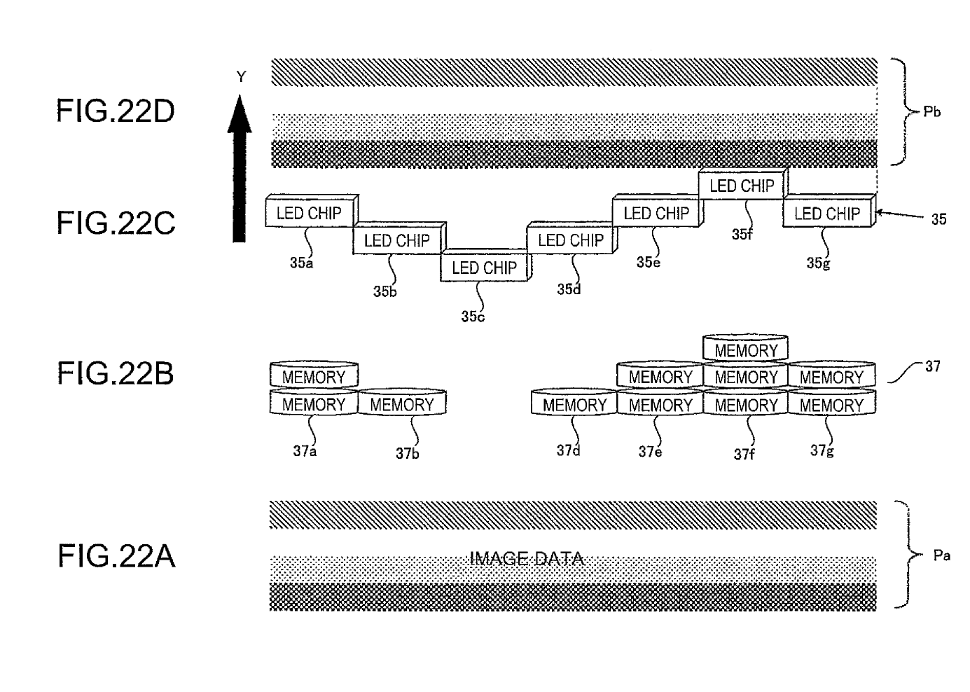

That is, the imaging lens arrays 7a to 7c and the corresponding light emitter array chips are arranged in a staggered manner. In the example shown in FIG. 2, to form a single row of latent images in the axial direction of the photoconductor, the delay memories described with reference to FIGS. 22A to 22D are used. With reference to the operation of the light emitting elements in the light emitter array chip that corresponds to the imaging lens array 7a, the operation of the light emitting elements in the light emitter array chip that corresponds to the imaging lens array 7b is delayed by one timing period relative to the reference operation. The operation of the light emitting elements in the light emitter array chip that corresponds to the imaging lens array 7c is delayed by two timing periods relative to the reference operation.

FIG. 23 is a descriptive diagram explaining the reason why the number of dots per light emitting element group (A) is selected to be a positive divisor of the number of dots per light emitter array chip (B). In FIG. 23, the same portions as those in FIG. 2 have the same reference characters and no detailed description thereof will be made. In FIG. 23, the number of dots in each of the light emitting element groups 6a, 6b, and 6c is not selected to be a divisor of the number of dots in each of the light emitter array chips 1a, 1b, and 1c. Therefore, the imaging lens 4c covers the joint portion (gap 1x) between the light emitter array chips 1a and 1b, disadvantageously resulting in an error in mounting the line head 10 and hence a white patch in the printing process.

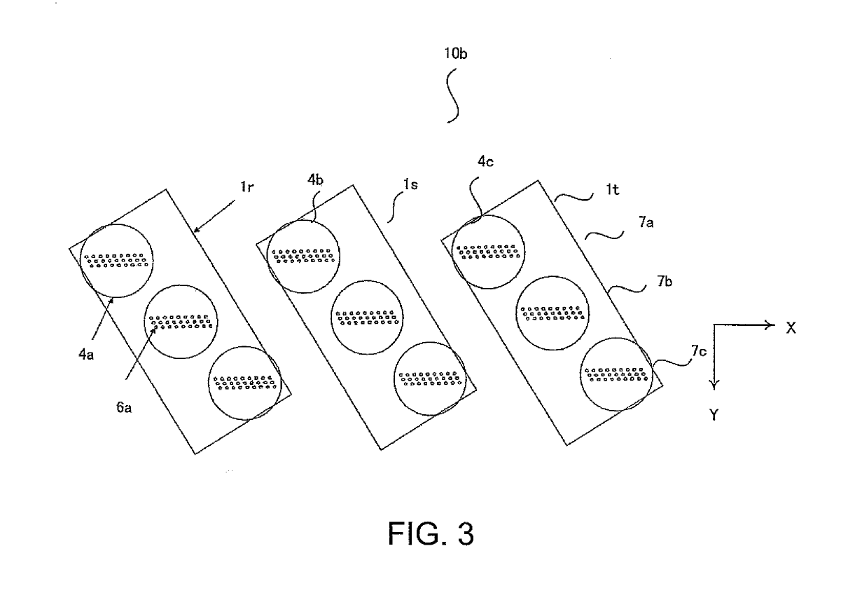

FIG. 3 is a descriptive diagram showing another embodiment of the invention. In this example, the imaging lens arrays 7a to 7c are arranged in the same manner as in FIG. 1, but light emitter array chips 1r to 1t are arranged differently. That is, the light emitter array chips 1r to 1t are arranged in the illustrated oblique direction with respect to the secondary scan direction (Y direction). The light emitting element group 6a and other groups formed in the light emitter array chips 1r to 1t correspond to the individual imaging lens 4a and other lenses, respectively. In FIG. 3 as well, the relationship between the number of dots per light emitting element group for a single imaging lens (A) and the number of dots per light emitter array chip (B) is the same as that in the example shown in FIG. 1. The number of dots per light emitting element group (A) is 27, and the number of dots per light emitter array chip (B) is 27×3=81. That is, A is set to be a divisor of B (the greatest common divisor is 27 in this case).

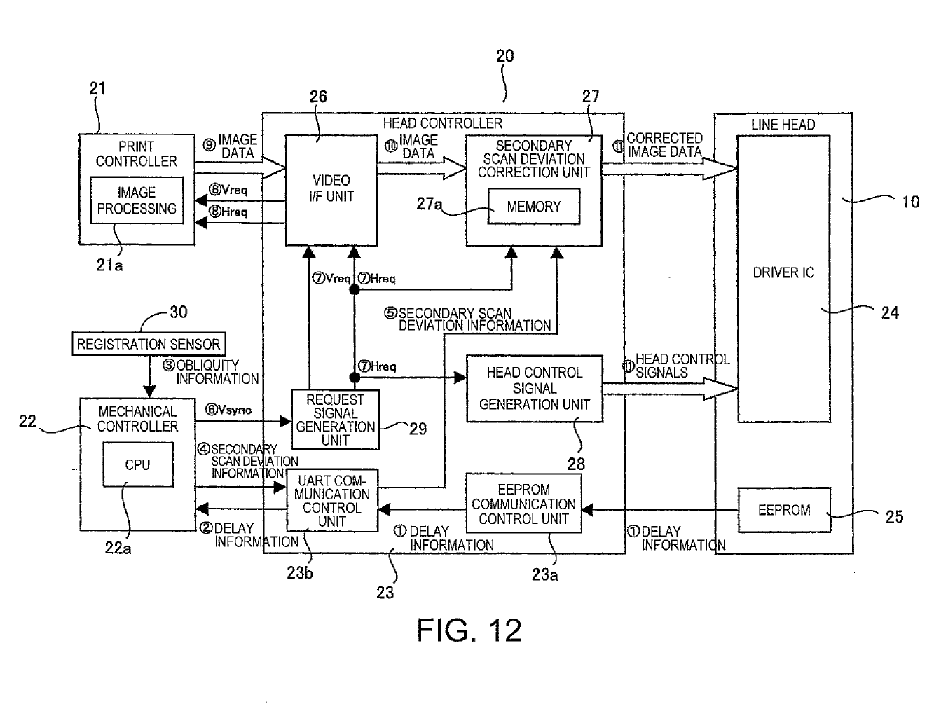

FIG. 12 is a block diagram of a control unit in an embodiment of the invention. The line head 10 includes a driver IC 24 that controls light emitting elements and an EEPROM 25 that stores delay information created based on curvature deviation of the line head. The control unit 20 includes a print controller 21, a mechanical controller 22, and a head controller 23.

The print controller 21 has an image processing unit 21a, and the mechanical controller 22 has an arithmetic processing unit (CPU) 22a. The head controller 23 has an EEPROM communication control unit 23a, a UART (Universal Asynchronous Receiver Transmitter) control unit 23b, a video I/F 26, a secondary scan deviation correction unit 27 having a memory 27a, a head control signal generation unit 28, and a request signal generation unit 29. Detection information from a registration sensor 30 is inputted to the mechanical controller 22.

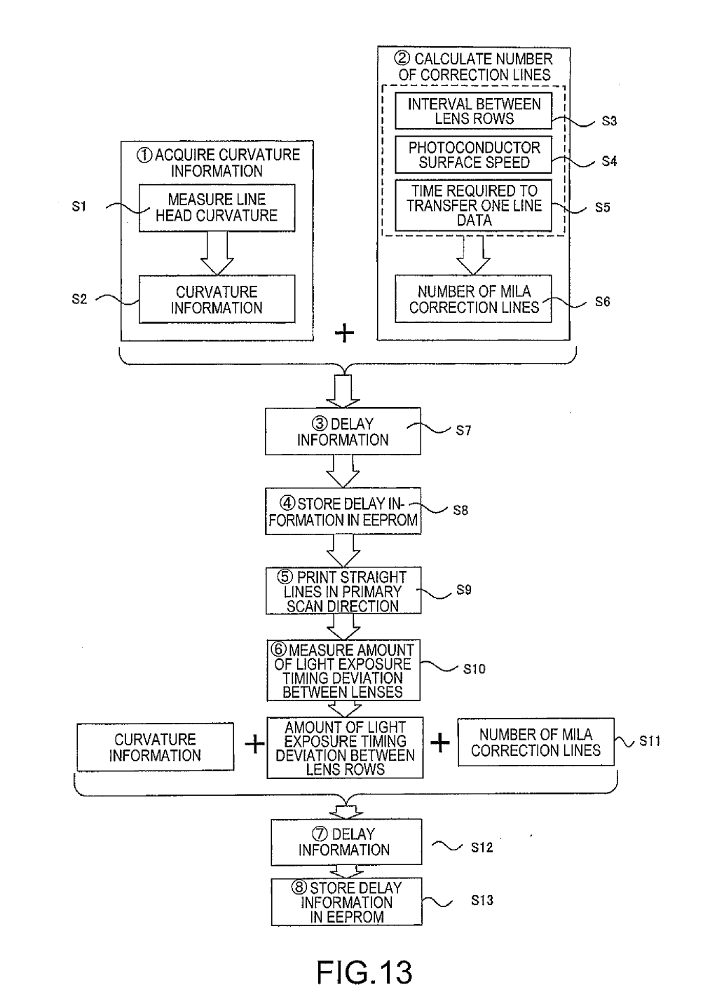

The control procedure in FIG. 12 will be described below. It is noted that encircled numbers will be expressed as [1], for example, from conversion reasons. When the printer is turned on, the EEPROM communication control unit 23a reads delay information from the EEPROM 25 and sends it to the UART communication control unit 23b ([1]). A method for acquiring delay information will be described later with reference to FIG. 13. The UART communication control unit 23b sends the delay information to the mechanical controller 22 ([2]).

The mechanical controller 22 causes a registration pattern to be printed, uses the registration sensor 30 to detect the result of the print operation, and calculates obliquity information ([3]). The mechanical controller 22 adds the obliquity information to the delay information to calculate secondary scan deviation information, and sends it to the UART communication control unit 23b ([4]). The UART communication control unit 23b sends the secondary scan deviation information to the secondary scan deviation correction unit 27 ([5]). The secondary scan deviation correction unit 27 stores the received secondary scan deviation information in a register in the memory 27a.

When a print operation starts, the mechanical controller 22 detects an end of a sheet of paper and sends a Vsync signal (video synchronization signal) to the request signal generation unit 29 ([6]). The request signal generation unit 29 produces a Vreq signal (video data request signal) and an Hreq signal (line data request signal) and sends them to the video I/F unit ([7]). At the same time, the Hreq signal is also sent to the secondary scan deviation correction unit 27 and the head control signal generation unit 28 to synchronize the modules. The video I/F unit 26 sends the Vreq and Hreq signals to the print controller ([8]).

The print controller 21 uses the received Vreq and Hreq signals as a trigger to send image data that have undergone image processing to the video I/F unit 26 ([9]). In this process, to reduce wiring cost and facilitate routing wiring lines, the parallel image data are desirably converted into serial data (parallel-to-serial conversion) for transmission in high-speed serial communication. Since a micro-lens having a negative optical magnification is used as the imaging lens, the image processing includes sorting the data order in the primary and secondary scan directions in accordance with the negative optical magnification. The sorting may alternatively be carried out in the head controller 23 or the line head 10. The video I/F unit 26 converts the serial image data into parallel image data and sends them to the secondary scan deviation correction unit 27 ([10]).

The secondary scan deviation correction unit 27 uses a plurality of line memories to correct the secondary scan deviation in latent image forming position at a predetermined primary scan resolution and sends the corrected image data to the line head 10 ([11]). At the same time, the head control signal generation unit 28 produces a variety of head control signals (a clock, a start signal, a reset signal, and other signals) and sends them to the line head 10 ([11]).

The resolution of the secondary scan deviation correction in the primary scan direction is set on an imaging lens basis (on a light emitting element group basis). Since the operation timing is thus controlled on a light emitting element group basis for an imaging lens, secondary scan deviation generated in an area where light emitter array chips are connected or in an area where imaging lenses are connected can be corrected. A method for acquiring latent image forming position deviation information in the secondary scan direction will be described later.

FIG. 13 is a flowchart showing the procedure of acquiring delay information stored in the EEPROM 25 shown in FIG. 12. In FIG. 13, curvature information on the line head is first acquired ([1]). In this process, the amount of line head curvature is measured by an optical sensor or any other similar sensor (S1) and converted into curvature information on a line basis (S2). The number of correction lines are then calculated ([2]). In this process, the interval between lens rows (S3), the photoconductor surface speed (S4), and the time required to transfer one line data (S5) are determined. These values and the equations (1) and (2) described above are used to calculate the number of MLA correction lines (S6). In the following process ([3]), the curvature information is added to the number of MLA correction lines to calculate delay information (S7).

The following processes are then carried out: Storing the delay information in the EEPROM ([4], S8), printing an image having straight lines drawn therein in the primary scan direction ([5], S9), and measuring the amount of light exposure timing deviation between lenses present in the printed result by using an optical microscope or any other similar apparatus ([6], S10). Subsequently, the amount of light exposure timing deviation between lenses, the curvature information, and the number of MLA correction lines are combined (S11) to recalculate the delay information ([7], S12). Finally, the delay information is stored in the EEPROM (non-volatile memory) ([8], S13).

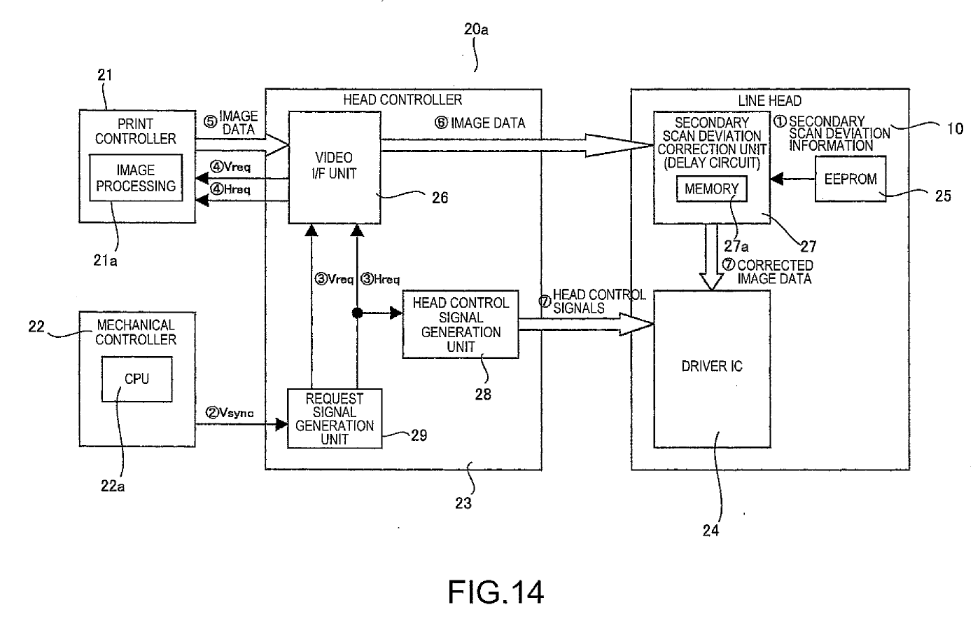

FIG. 14 is a block diagram of a control unit 20a in another embodiment of the invention. In FIG. 14, the same portions as those in FIG. 12 have the same reference characters and no detailed description thereof will be made. The line head includes not only the drive IC 24 and the EEPROM 25 but also the secondary scan deviation correction unit 27 The secondary scan deviation correction unit 27 serves as a delay circuit, as will be described later. The configuration of the print controller 21 and the configuration of the mechanical controller 22 are the same as those shown in FIG. 12. The head controller 23 has the video I/F 26, the head control signal generation unit 28, and the request signal generation unit 29.

The process procedure in FIG. 14 will be described below. When the printer is turned on, secondary scan deviation information stored in advance in the EEPROM is read therefrom, and is sent to the secondary scan deviation correction unit (delay circuit) ([1]). When a printing operation starts, the mechanical controller 22 detects an end of a sheet of paper and sends a Vsync signal to the request signal generation unit ([2]).

The request signal generation unit 29 produces a Vreq signal (video data request signal) and an Hreq signal (line data request signal) and sends them to the video I/F unit 26 ([3]). At the same time, the Hreq signal is also sent to the secondary scan deviation correction unit 27 and the head control signal generation unit 28 to synchronize the modules.

The video I/F unit 26 sends the Vreq and Hreq signals to the print controller 21 ([4]). The print controller 21 uses the received Vreq and Hreq signals as a trigger to send image data that have undergone image processing to the video I/F unit 26 ([5]). In this process, to reduce wiring cost and facilitate routing wiring lines, the parallel image data are desirably converted into serial data (parallel-to-serial conversion) for transmission in high-speed serial communication.

The video I/F unit 26 converts the serial image data into parallel image data and sends them to the secondary scan deviation correction unit 27 in the head ([6]). The secondary scan deviation correction unit 27 uses a plurality of line memories to correct the secondary scan deviation at a predetermined primary scan resolution and sends the corrected image data to the driver IC in the line head ([7]). At the same time, the head control signal generation unit 28 produces a variety of head control signals (a clock, a start signal, a reset signal, and other signals) and sends them to the driver IC in the line head ([7]).

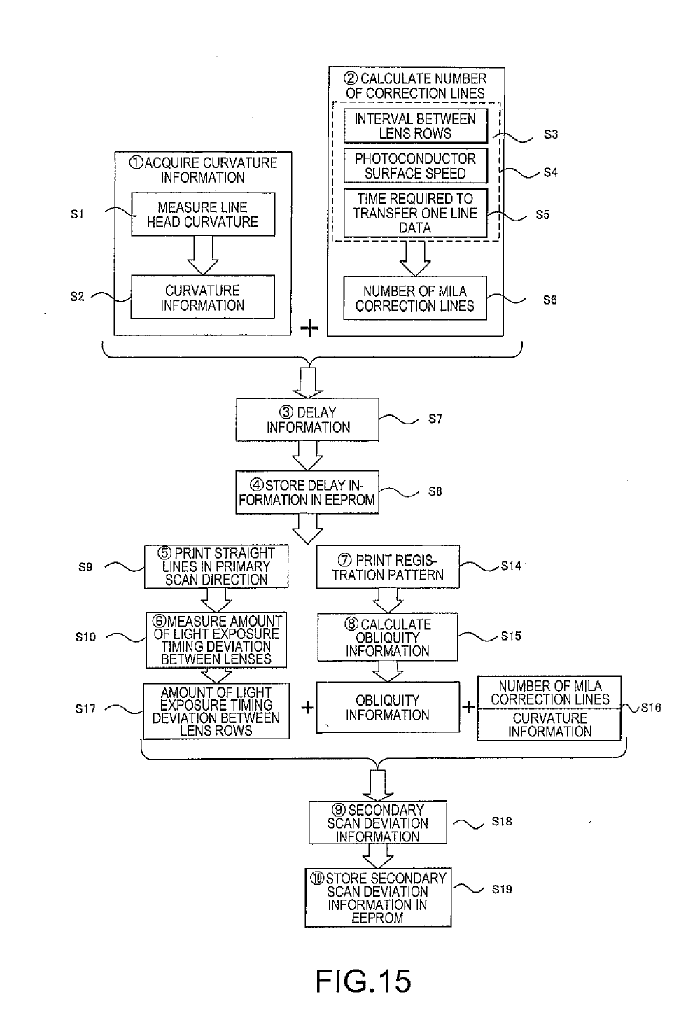

FIG. 15 is a flowchart showing the procedure of acquiring latent image forming position deviation information in the secondary scan direction. In FIG. 15, the same processes as those in FIG. 13 have the same step (S) numbers. Since the processes [1] to [6] are the same as those in FIG. 13, no description of the encircled numbers in these portions will be made. The amount of line head curvature is measured by an optical sensor or any other similar sensor (S1), and converted into curvature information on a line basis (S2). The interval between lens rows (S3), the photoconductor surface speed (S4), and the time required to transfer one line data (S5) and the equations (1) and (2) are used to calculate the number of MLA correction lines (S6).

The curvature information (S2) is added to the number of MLA correction lines (S6) to calculate delay information (S7), and the delay information is stored in the EEPROM (S8). An image having straight lines drawn therein in the primary scan direction is printed (S9), and an optical microscope or any other similar apparatus is used to measure the amount of light exposure timing deviation between lens rows present in the printed result (S10). A registration pattern is printed ([7], S14), and the printed result is detected by a registration sensor or any other similar device to calculate obliquity information ([8], S15).

In the process in S17, the amount of light exposure timing deviation between lens rows (S10), the obliquity information (S15), the curvature information (S2), and the number of MLA correction lines (S16) are combined to calculate the secondary scan deviation information ([9], S18). The secondary scan deviation information is stored in the EEPROM ([10], S19).

In the embodiment of the invention, an LED, an organic EL, a VCSEL (vertical Cavity Surface Emitting LASER), or any other similar device can be used as the light emitting element in the light emitter array. An SLA (Selfoc Lens Array), an MLA (Micro Lens Array), and any other similar device can be used as the lens array.

As described above, in the embodiment of the invention, when obliquity and curvature deviation of the line head is corrected, the light exposure timing deviation between MLA lenses and the deviation between light emitter array chips can be simultaneously corrected, whereby a high image quality printed image can be provided to a user. Further, the correction resolution in the primary scan direction can be set on a lens basis (on a light emitting element group basis) to reduce the amount of data (memory capacity), whereby an inexpensive image formation apparatus can be provided to a user.

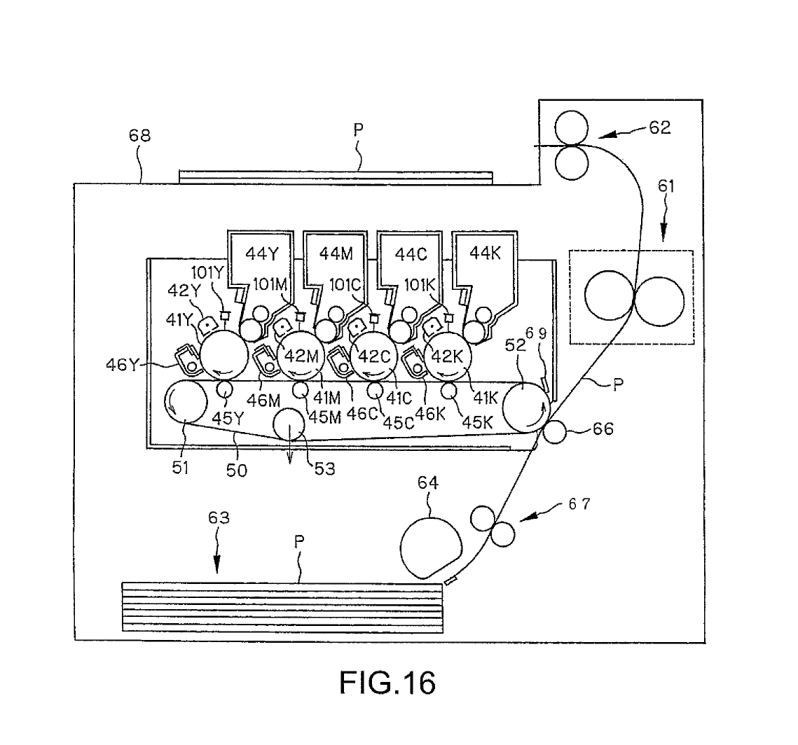

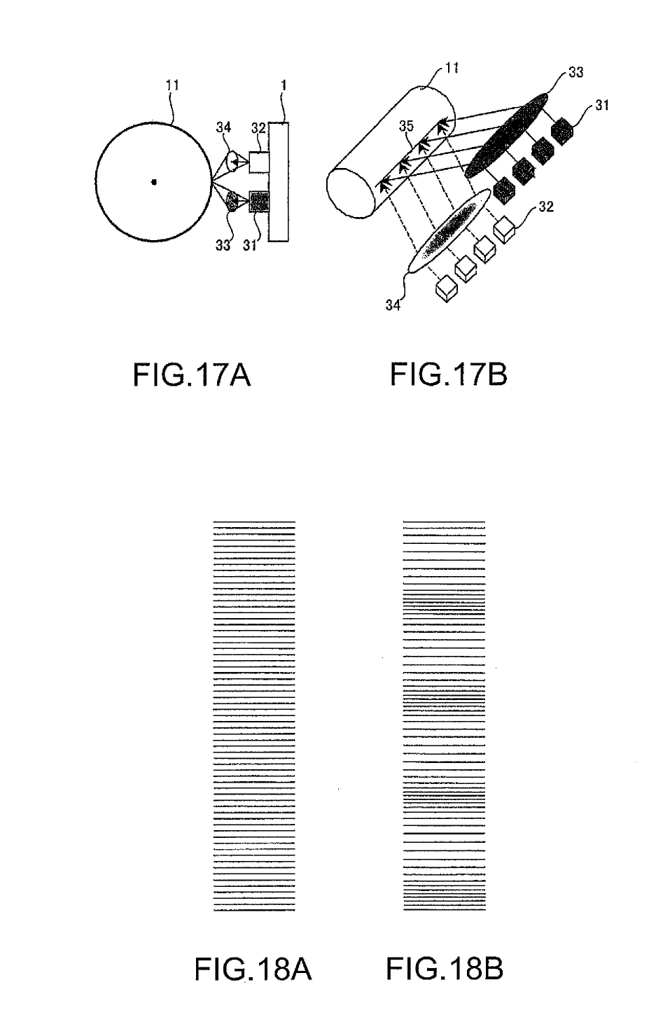

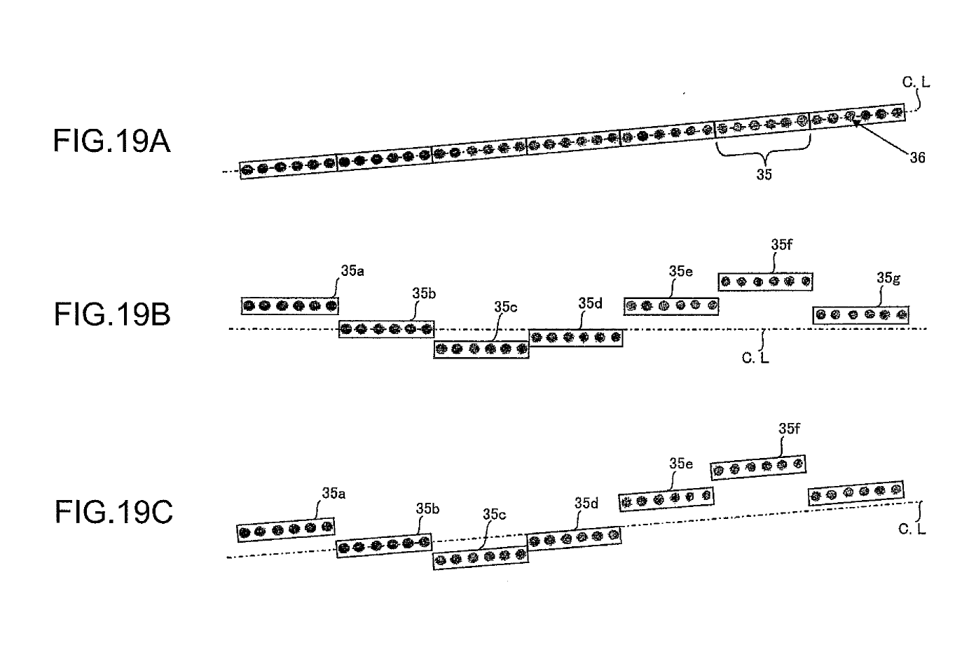

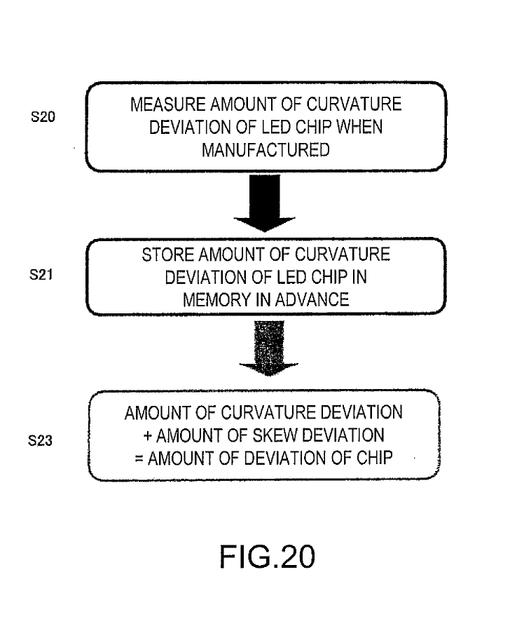

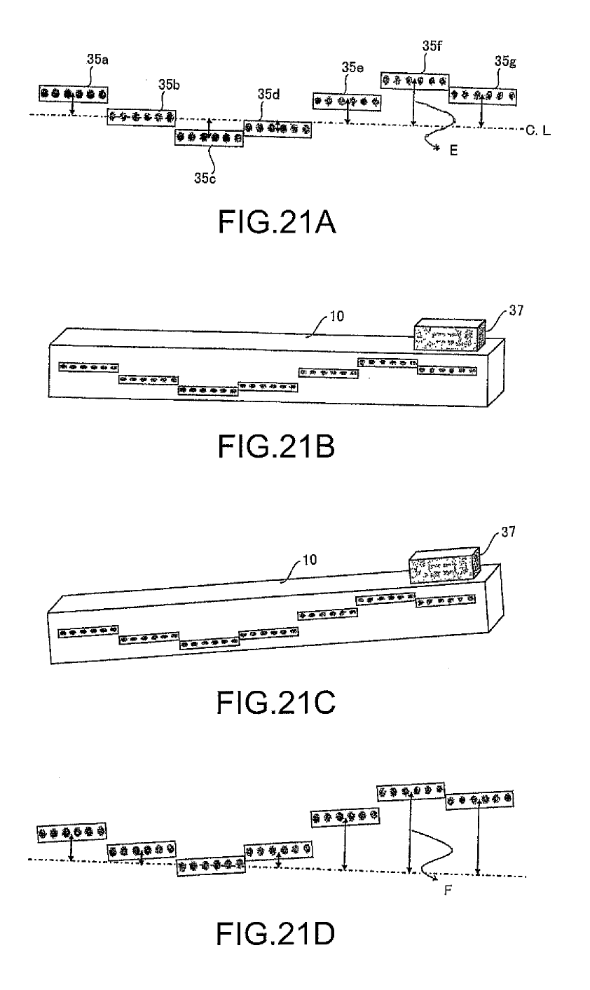

The embodiment of the invention is directed to a line head used in a tandem color printer (image formation apparatus) in which four line heads are used to expose four photoconductors to light to simultaneously form four color images, which are transferred onto a single endless intermediate transfer belt (intermediate transfer medium). FIG. 16 is a longitudinal cross-sectional side view showing an example of the tandem image formation apparatus using LEDs as light emitting elements. In the image formation apparatus, four line heads 101K, 101C, 101M, and 101Y having the same configuration are arranged in light exposure positions where corresponding four photoconductors (image carriers) 41K, 41C, 41M, and 41Y having the same configuration are exposed to light.

As shown in FIG. 16, the image formation apparatus includes a drive roller 51, a driven roller 52, and a tension roller 53, as well as an intermediate transfer belt (intermediate transfer medium) 50 that is driven and rotated by the tension roller 53 in the direction indicated by the illustrated arrows (counterclockwise direction). The photoconductors 41K, 41C, 41M, and 41Y are arranged at predetermined intervals in such a way that they face the intermediate transfer belt 50. The letters K, C, M, and Y appended to the reference characters stand for black, cyan, magenta, and yellow, respectively. The photoconductors 41K to 41Y are driven and rotated in the direction indicated by the illustrated arrows (clockwise direction) in synchronization with the drive operation of the intermediate transfer belt 50. Chargers 42 (K, C, M, and Y) and the line heads 101 (K, C, M, and Y) are provided around the photoconductors 41 (K, C, M, and Y), respectively.

The image formation apparatus further includes developing devices 44 (K, C, M, and Y) that add toner, which is a developing agent, to electrostatic latent images formed by the line heads 101 (K, C, M, and Y) to convert them into visible images, primary transfer rollers 45 (K, C, M, and Y), and cleaning devices 46 (K, C, M, and Y). The line heads 101 (K, C, M, and Y) are configured to emit light whose energy peak wavelengths are in substantial agreement with the sensitivity peak wavelengths of the photoconductors 41 (K, C, M, and Y).

The black, cyan, magenta, and yellow toner images formed by such four single-color toner image forming stations are sequentially transferred onto the intermediate transfer belt 50 in a primary transfer process by a primary transfer bias applied to the primary transfer rollers 45 (K, C, M, and Y). The toner images are sequentially superimposed on the intermediate transfer belt 50 into a full-color toner image. A secondary transfer roller 66 transfers the full-color toner image onto a recording medium P, such as a sheet of paper, in a secondary transfer process. The full-color toner image is fixed on the recording medium P when it passes through a pair of fixing rollers 61, which is a fixing unit. A pair of ejecting rollers 62 eject the recording medium P onto an ejection tray 68 formed in an upper portion of the apparatus.

Reference numeral 63 denotes a sheet feed cassette in which a large number of recording media P are stacked and retained. Reference numeral 64 denotes a pickup roller that feeds a recording medium P one by one from the sheet feed cassette 63. Reference numeral 65 denotes a pair of gate rollers that define the timing of supplying a recording medium P to a secondary transfer unit formed of the secondary transfer roller 66. Reference numeral 66 denotes the secondary transfer roller as a secondary transfer means, the secondary transfer roller 66 and the intermediate transfer belt 50 forming the secondary transfer unit. Reference numeral 67 denotes a cleaning blade that removes toner left on the surface of the intermediate transfer belt 50 after the secondary transfer operation.

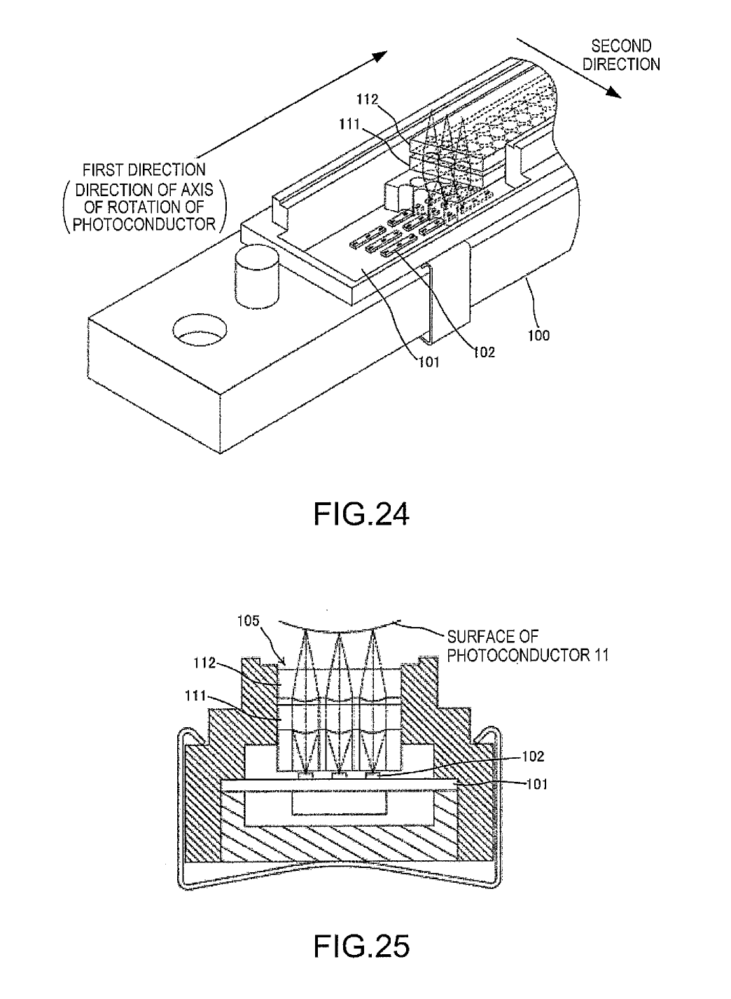

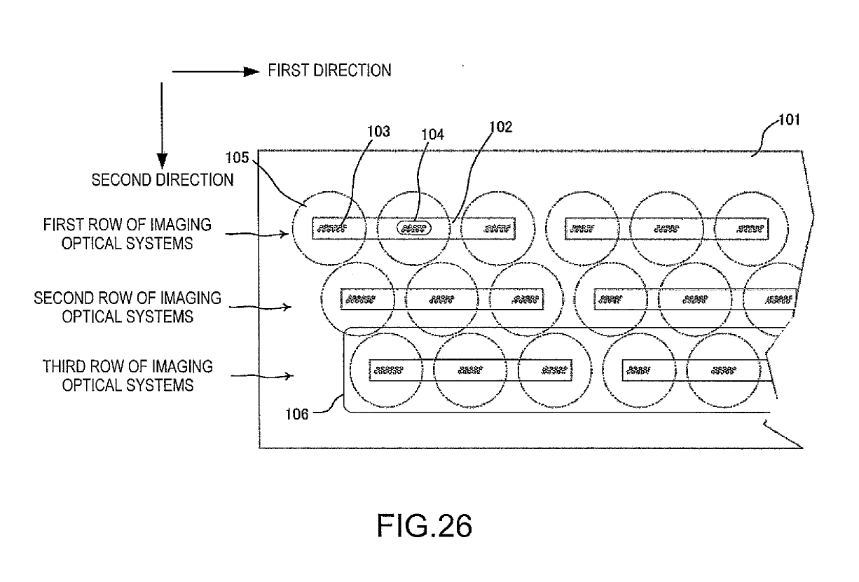

Another embodiment of the invention will be described below. FIGS. 24 to 26 are descriptive diagrams showing another embodiment of the invention. FIG. 24 is a perspective view of part of a light exposure head. FIG. 25 is a cross-sectional view of the light exposure head. FIG. 26 is a partial view of the light exposure head showing the layout of a substrate on the base and imaging optical systems.

In FIGS. 24 to 26, reference numeral 100 denotes the light exposure head. Reference numeral 101 denotes the base. Reference numeral 102 denotes the substrate. Reference numeral 103 denotes a light emitting element. Reference numeral 104 denotes a group of light emitting elements. Reference numeral 105 denotes the imaging optical system. Reference numeral 106 denotes a row of imaging optical systems. Reference numeral 111 denotes a first lens. Reference numeral 112 denotes a second lens. The light exposure head 100 corresponds to the line head described in the previous embodiment.

The light exposure head 100 has an elongated shape along the axis of rotation (not shown) of a photoconductor 11, and disposed to face the photoconductor 11. The axis of rotation of the photoconductor 11 is defined herein as a first direction. The photoconductor 11 rotates when it receives rotational drive force from a driver (not shown) through a mechanism, such as a gear. A charger (not shown) charges the surface of the photoconductor 11, and then the light exposure head 100 writes electrostatic latent images on the photoconductor 11.

A plurality of light emitting elements 103 provided on the substrate 102 are used as the light source in the light exposure head 100. In the present embodiment, the light emitting element 103 is an LED element, and the substrate 102 is a unit formed of parts. Individual substrates 102 are attached to the base 101 as shown in FIG. 26 and other drawings to form the entire light source in the light exposure head 100. The configuration of the light exposure head 100 in which individual substrates 102 are separately attached has an inherent technical problem of easily producing skew registration deviation, curvature registration deviation, and other errors.

In the light exposure head 100, when any of the light emitting elements 103 is selectively turned on to emit light, the imaging optical system 105 focuses the light from the light emitting element 103 on the surface of the photoconductor 11 to write a predetermined electrostatic latent image on the surface of the photoconductor 11.

While an LED element is used as the light emitting element 103 in the present embodiment, the LED element may be replaced with an organic EL element.

In the present embodiment, the imaging optical system 105 is formed of the first lens 111 and the second lens 112, which focus the light emitted from a light emitting element 103 on the surface of the photoconductor 11. While the two lenses, the first lens 111 and the second lens 112, form the imaging optical system 105 in the present embodiment as described above, the imaging optical system may include more lenses or may be formed of a single lens.

In the present embodiment, a lens array having a plurality of lenses bundled in the separate direction is used as the first lens 111 and the second lens 112.

In the present embodiment, a micro-lens array is used as the imaging optical system 105, and the imaging optical system has a negative optical magnification. Such a micro-lens array (MLA), which is an imaging optical system having a negative optical magnification, may be replaced with an SLA (Selfoc Lens Array), which is an imaging optical system having a positive optical magnification.

As shown in FIG. 26, individual substrates 102 are attached to the base 101. Ten light emitting elements 103 formed on a substrate 102 form a group of light emitting elements 104, and three groups of light emitting elements 104 are disposed on a substrate 102 at predetermined intervals. A single imaging optical system 105 is responsible for the imaging operation of all the light emitting elements 103 that belong to a group of light emitting elements 104.

The direction perpendicular to the first direction is herein defined as a second direction. In a group of light emitting elements 104, five light emitting elements 103 are arranged in a row along the first direction, and another five light emitting elements 103 are arranged in a row and shifted in the first and second directions relative to the first row of light emitting elements 103.

A row of imaging optical systems 106 (first row) is formed in correspondence with groups of light emitting elements 104 along the first direction. A second row of imaging optical systems 106 is laid out in such a way that it is shifted in the first and second directions, and a third row of the imaging optical systems 106 is laid out in such a way that it is further shifted in the first and second directions.

A description will be made of patterns of light emission control of the light emitting elements 103 in the thus configured light exposure head 100.

As a first pattern, light emission control of the light emitting elements 103 in the light exposure head 100 is carried out by using data that correct skew deviation on an imaging optical system 105 basis, whereby the skew deviation including a positional error of the imaging optical system 105 can be corrected.

As a second pattern, light emission control of the light emitting elements 103 in the light exposure head 100 is carried out by using data that correct skew deviation on a substrates 102 basis, whereby the skew deviation including a mounting error of the substrates 102 can be corrected.

As a third pattern, light emission control of the light emitting elements 103 in the light exposure head 100 is carried out by using data that correct skew deviation not on an imaging optical system 105 basis or a substrates 102 basis but on a certain component basis, whereby the skew correction can be precisely carried out because positional errors of the substrates 102 and the imaging optical systems 105 do not interfere with the skew correction.

In the thus configured light exposure head 100, three rows of imaging optical systems 106, each of the imaging optical systems 106 focusing light beams from a single group of light emitting elements 104, are provided to be slightly shifted in the first and second directions.

With the arrangement described above, the light beams focused by the rows of imaging optical systems disposed in the second direction are focused not only in different positions on the photoconductor 11 in the second direction but also in different positions on the photoconductor 11 in the first direction. With such an arrangement, perceptible, periodic grayscales resulting from, for example, skew registration deviation and curvature registration deviation produced by attaching substrates to a base are dispersed in all directions in an image to be formed, whereby image quality degradation due to the above effects can be suppressed.

With the arrangement according to the present embodiment, since the locations where grayscales resulting from banding are produced are dispersed in all directions in an image to be formed, image quality degradation due to banding becomes less noticeable.

While the light exposure head, the line head, and the image formation apparatus using the same have been described with reference to the above embodiments, the invention is not limited thereto but a variety of changes can be made thereto.

What is claimed is:

1. A light exposure head comprising:
a base;
a substrate disposed on the base, the substrate having a plurality of light emitting elements disposed thereon; and
n (n is an integer greater than or equal to one) imaging optical systems, each of which having a negative optical magnification, the imaging optical systems focusing light beams emitted from the plurality of light emitting elements disposed on the substrate.

2. The light exposure head according to claim 1,
wherein a plurality of the substrates are disposed on the base in a first direction, and light beams emitted from the light emitting elements disposed on an adjacent substrate in the first direction are focused by a different imaging optical system.

3. The light exposure head according to claim 1,
wherein a plurality of the substrates are disposed in a second direction perpendicular to the first direction.

4. The light exposure head according to claim 3,
wherein one of the imaging optical systems focuses light beams emitted from the light emitting elements disposed on any of the plurality of the substrates disposed in the second direction.

5. The light exposure head according to claim 1,
wherein a plurality of the imaging optical systems are disposed in the first direction to form a row of imaging optical systems, and a plurality of the rows of imaging optical systems are disposed in the second direction.

6. A light exposure head comprising:
a base;
a first substrate disposed on the base, the first substrate having a plurality of light emitting elements thereon;
a second substrate disposed on the base and adjacent to the first substrate in a first direction, the second substrate having a plurality of light emitting elements thereon;
a first imaging optical system having a negative optical magnification, the first imaging optical system focusing light beams emitted from the plurality of light emitting elements disposed on the first substrate; and
a second imaging optical systems having a negative optical magnification, the second imaging optical system focusing light beams emitted from the plurality of light emitting elements disposed on the second substrate.

7. The light exposure head according to claim 1,
wherein the imaging optical system is formed of two or more lenses.

8. The light exposure head according to claim 1,
wherein the light emitting element is an LED.

9. The light exposure head according to claim 1,
wherein the light emitting elements are segmented into groups of light emitting elements, and light beams emitted from one of the groups of light emitting elements are focused by one of the imaging optical systems.

10. An image formation apparatus comprising:
a light exposure head including a base, a plurality of substrates disposed on the base in a first direction, a plurality of light emitting elements disposed on each of the substrate, and n (n is an integer greater than or equal to one) imaging optical systems, each of which having a negative optical magnification, the imaging optical systems focusing light beams emitted from the plurality of light emitting elements;
a photoconductor on which the light exposure head forms latent images, the photoconductor moving in a second direction perpendicular or substantially perpendicular to the first direction; and
a developing device that develops the latent images.

11. The image formation apparatus according to claim 10,
wherein light beams emitted from the plurality of light emitting elements disposed on the plurality of substrates are focused on the photoconductor by different imaging optical systems.

12. The image formation apparatus according to claim 10,
wherein the imaging optical systems are disposed in the second direction, and the imaging optical systems disposed in different positions in the second direction form images on the photoconductor in different positions in the second direction.
